(19) United States
(12) Patent Application Publication
(10) Pub. No.: US 2025/0047724 A1
(43) Pub. Date: Feb. 6, 2025

(54) METHOD FOR WIRELESS COMMUNICATION, AND COMMUNICATION DEVICE

(71) Applicant: GUANGDONG OPPO MOBILE TELECOMMUNICATIONS CORP., LTD., Dongguan (CN)

(72) Inventors: Fei LU, Dongguan (CN); Haorui YANG, Dongguan (CN)

(21) Appl. No.: 18/920,374

(22) Filed: Oct. 18, 2024

Related U.S. Application Data
(63) Continuation of application No. PCT/CN2022/091155, filed on May 6, 2022.

(51) Int. Cl. H04L 65/1104; H04L 61/5014; H04L 65/1073; H04L 101/395; H04M 15/00

(52) U.S. Cl. CPC H04L 65/1104; H04L 61/5014; H04L 65/1073; H04M 15/66; H04L 2101/395

(57) ABSTRACT

Provided is a wireless communication method. The method includes: receiving a Session Initiation Protocol (SIP) registration request message from a remote terminal device, wherein the remote terminal device accesses the network via a relay terminal device, the SIP registration request message is sent by the remote terminal device to the first CN element via the relay terminal device, and the SIP registration request message comprises first information indicating that the remote terminal device accesses the network in a relay mode; and sending a SIP registration response message corresponding to the SIP registration request message to the remote terminal device.

### CROSS-REFERENCE TO RELATED APPLICATION

This application is a continuation of International Application No. PCT/CN2022/091155, filed May 6, 2022, the entire disclosure of which is incorporated herein by reference.

### TECHNICAL FIELD

Embodiments of the present disclosure relate to the field of communication technologies, and in particular, to a method and apparatus for wireless communication, a device, a storage medium, and a program product.

### BACKGROUND

The 3rd Generation Partnership Project (3GPP) introduces a Network Controlled Interactive Service (NCIS) into a 5th-generation (5G) new radio (NR) system.

The NCIS is introduced into standards as a new service form for related standardized services. The NCIS is mainly used for applications such as augmented reality (AR), virtual reality (VR), and games, and has high requirements for service quality such as a rate, latency, packet loss rate, and high-speed codec. Therefore, further research is needed for the NCIS.

### SUMMARY

Embodiments of the present disclosure provide a method for wireless communication and a communication device.

According to some embodiments of the present disclosure, a method for wireless communication is provided. The method is applicable to a first core network (CN) element in a network. The method includes:
receiving a Session Initiation Protocol (SIP) registration request message from a remote terminal device, wherein the remote terminal device accesses the network via a relay terminal device, the SIP registration request message is sent by the remote terminal device to the first CN element via the relay terminal device, and the SIP registration request message includes first information indicating that the remote terminal device accesses the network in a relay mode; and
sending a SIP registration response message corresponding to the SIP registration request message to the remote terminal device.

According to some embodiments of the present disclosure, a method for wireless communication is provided. The method is applicable to a remote terminal device. The remote terminal device accesses a network via a relay terminal device. The method includes:
sending a SIP registration request message to the relay terminal device, wherein the SIP registration request message is sent by the relay terminal device to a first CN element in the network, and the SIP registration request message includes first information indicating that the remote terminal device accesses the network in a relay mode; and
receiving a SIP registration response message corresponding to the SIP registration request message from the first CN element.

According to an aspect of the embodiments of the present disclosure, a communication device is provided. The communication device includes a processor and a memory storing one or more computer programs. The processor, when loading and running the one or more computer programs, is caused to perform the foregoing method for wireless communication executed by the first CN element or the remote terminal device.

### BRIEF DESCRIPTION OF DRAWINGS

FIG. 1 is a schematic diagram of a network architecture according to some embodiments of the present disclosure;

FIG. 2 is a schematic diagram of a 5G system architecture according to some embodiments of the present disclosure;

FIG. 3 is a schematic diagram of a 5G system architecture according to some other embodiments of the present disclosure;

FIG. 4 is a schematic diagram of a 5G system architecture according to some other embodiments of the present disclosure;

FIG. 5 is a flowchart of a method for wireless communication according to some embodiments of the present disclosure;

FIG. 6 is a schematic diagram of a network architecture according to some other embodiments of the present disclosure;

FIG. 7 is a flowchart of a method for wireless communication according to some other embodiments of the present disclosure;

FIG. 8 is a flowchart of a method for wireless communication according to some other embodiments of the present disclosure;

FIG. 9 is a schematic diagram of Open Systems Interconnection (OSI) reference model of a computer network according to some embodiments of the present disclosure;

FIG. 10 is a flowchart of a method for wireless communication according to some other embodiments of the present disclosure;

FIG. 11 is a flowchart of a method for wireless communication according to some other embodiments of the present disclosure;

FIG. 12 is a flowchart of a method for wireless communication according to some other embodiments of the present disclosure;

FIG. 13 is a block diagram of an apparatus for wireless communication according to some embodiments of the present disclosure;

FIG. 14 is a block diagram of an apparatus for wireless communication according to some other embodiments of the present disclosure;

FIG. 15 is a block diagram of an apparatus for wireless communication according to some other embodiments of the present disclosure;

FIG. 16 is a block diagram of an apparatus for wireless communication according to some other embodiments of the present disclosure;

FIG. 17 is a block diagram of an apparatus for wireless communication according to some other embodiments of the present disclosure;

FIG. 18 is a block diagram of an apparatus for wireless communication according to some other embodiments of the present disclosure;

FIG. 19 is a schematic structural diagram of a terminal device according to some embodiments of the present disclosure; and

FIG. 20 is a schematic structural diagram of a CN element according to some embodiments of the present disclosure.

### DETAILED DESCRIPTION

To make the objective, technical solutions, and advantages of the present disclosure clearer, the embodiments of the present disclosure will be further described in detail with reference to the accompanying drawings.

A network architecture and a service scenario described in the embodiments of the present disclosure are intended to more clearly describe the technical solutions in the embodiments of the present disclosure, and do not constitute a limitation on the technical solutions provided in the embodiments of the present disclosure. A person of ordinary skill in the art may understand that, with the evolution of the network architecture and emergence of a new service scenario, the technical solutions provided in the embodiments of the present disclosure are also applicable to a similar technical problem.

The technical solutions in the embodiments of the present disclosure are applicable to various communication systems, such as a global system for mobile communications (GSM), a code division multiple access (CDMA) system, a wideband code division multiple access (WCDMA) system, a general packet radio system (GPRS), a long term evolution (LTE) system, an LTE-advanced (LTE-A) system, an NR system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi) network, a 5G communication system, or another communication system.

Generally, the conventional communication system supports a limited quantity of connections and is easy to implement. However, with development of communication technologies, a mobile communication system supports device to device (D2D) communication, machine to machine (M2M) communication, machine type communication (MTC), vehicle to vehicle (V2V) communication, vehicle to everything (V2X) communication, and the like in addition to conventional communication. The embodiments of the present disclosure are applicable to these communication systems.

The communication system in the embodiments of the present disclosure is applicable to a carrier aggregation (CA) scenario, a dual connectivity (DC) scenario, and a standalone (SA) networking scenario.

The communication system in the embodiments of the present disclosure is applicable to an unlicensed spectrum. The unlicensed spectrum may also be considered as a shared spectrum. Alternatively, the communication system in the embodiments of the present disclosure is applicable to a licensed spectrum. The licensed spectrum may also be considered as an unshared spectrum.

The embodiments of the present disclosure are applied to the NTN system and a terrestrial network (TN) system.

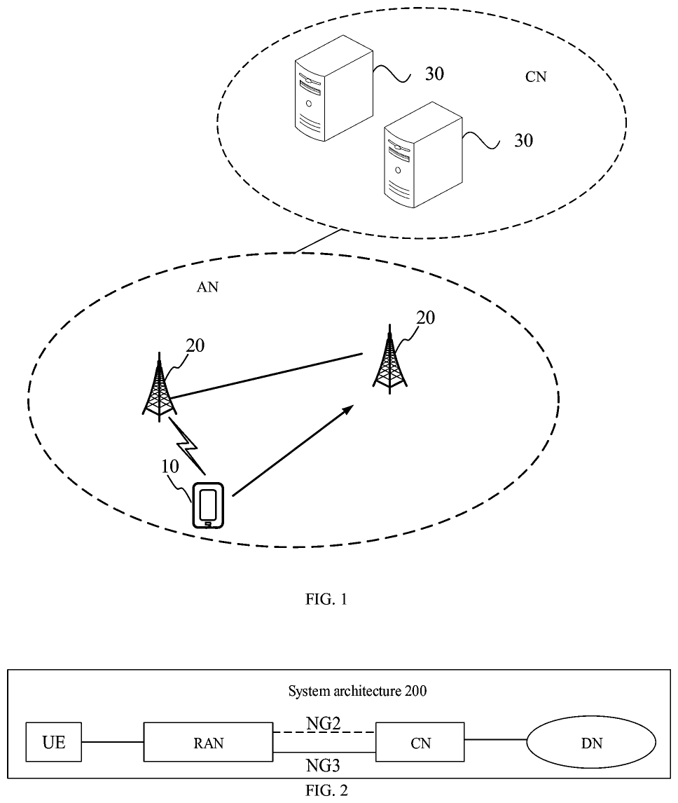

FIG. 1 is a schematic diagram of a network architecture according to some embodiments of the present disclosure. The network architecture includes a terminal device 10, an access network (AN) device 20, and a CN element 30.

The terminal device 10 is a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 is alternatively a cellular phone, a cordless phone, a SIP phone, a wireless local loop (WLL) station, a personal digital assistant (PDA), a handheld device with a wireless communication function, a computing device or another processing device connected to a wireless modem, a vehicle-mounted device, a wearable device, a terminal device in a 5G system, a terminal device in a future evolved public land mobile network (PLMN), or the like. This is not limited in the embodiments of the present disclosure. For convenience of description, the devices mentioned above are collectively referred to as the terminal device. There are usually a plurality of terminal devices 10. One or more terminal devices 10 are distributed in a cell managed by each AN device 20. In the embodiments of the present disclosure, the “terminal device” and “UE” are usually used interchangeably, but a person skilled in the art can understand their meanings.

The AN device 20 is a device deployed in an AN to provide a wireless communication function for the terminal device 10. The AN device 20 includes various forms of macro base stations, micro base stations, relay stations, access points, and the like. In systems employing different radio access technologies, devices with a function of the AN device may have different names, for example, gNodeB or gNB in a 5G NR system. As the communication technology evolves, the name “AN device” may change. For convenience of description, in the embodiments of the present disclosure, apparatuses providing the wireless communication function for the terminal device 10 are collectively referred to as the AN device. In some embodiments, a communication relationship is established between the terminal device 10 and the CN element 30 via the AN device 20. For example, in an LTE system, the AN device 20 is one or more eNodeBs in an evolved universal terrestrial radio access network (E-UTRAN). In the 5G NR system, the AN device 20 is one or more gNBs in a radio access network (RAN).

The CN element 30 is a network element deployed in a CN. The main functions of the CN element 30 are to provide user connections, manage users, complete bearers for services, and provide an interface to an external network as a bearer network. For example, CN elements in the 5G NR system include network elements such as an access and mobility management function (AMF), a user plane function (UPF), and a session management function (SMF). In addition, the CN element is regarded as a function entity. One or more CN elements are deployed on one physical device.

In some embodiments, the AN device 20 and the CN element 30 communicate with each other through a specific air interface technology, such as an NG interface in the 5G NR system. The AN device 20 and the terminal device 10 communicate with each other through a specific air interface technology, such as a Uu interface.

The “5G NR system” in the embodiments of the present disclosure may also be referred to as a 5G system or an NR system, but a person skilled in the art can understand its meaning. The technical solutions described in the embodiments of the present disclosure is applicable to the LTE system, the 5G NR system, an evolved system subsequent to the 5G NR system, a Narrowband Internet of Things (NB-IoT) system, or the like. This is not limited in the present disclosure.

In the embodiments of the present disclosure, the AN device provides services for a cell. The terminal device communicates with the AN device over transmission resources (for example, frequency domain resources or spectrum resources) on a carrier used by the cell. The cell may be a cell corresponding to the AN device (for example, a base station). The cell may belong to a macro base station or a base station corresponding to a small cell. The small cell includes a metro cell, micro cell, pico cell, femto cell, or the like. The small cell features small coverage and low transmission power, and is suitable for providing high-rate data transmission services.

FIG. 2 is a schematic diagram of a 5G system architecture according to some embodiments of the present disclosure. As shown in FIG. 2, the system architecture 200 includes UE (namely the “terminal device” as described above), a (radio) AN ((R)AN), a CN, and a data network (DN). The UE, (R)AN, and CN are main components of the architecture. Logically, they may be divided into two parts: a user plane and a control plane. The control plane is responsible for managing a mobile network. The user plane is responsible for transmitting service data. In the figure, an NG2 reference point is located between the (R)AN control plane and the CN control plane. An NG3 reference point is located between the (R)AN user plane and the CN user plane. An NG6 reference point is located between the CN user plane and the DN.

The UE is an entrance for a mobile user to interact with the network, and capable of providing basic computing capabilities and storage capabilities, displaying a service window to the user, and receiving user operation input. The UE establishes a signal connection and a data connection to the (R)AN through a next-generation air interface technology, to transmit control signals and service data to the mobile network.

The (R)AN is similar to a base station in a conventional network. Deployed close to the UE, the (R)AN provides a network access function for an authorized user in a specific area and can transmit user data over transmission tunnels of different quality based on a user level and a service requirement. The (R)AN manages its own resources, properly utilize them, provides an access service for the UE as needed, and forwards control signals and user data between the UE and the CN.

The CN is responsible for maintaining subscription data of the mobile network, managing network elements of the mobile network, and providing functions such as session management, mobility management, policy management, and security authentication for the UE. The CN provides network access authentication for the UE when the UE registers; allocates network resources to the UE when the UE has a service request; updates network resources for the UE when the UE moves; provides a fast recovery mechanism for the UE when the UE is idle; releases network resources for the UE when the UE deregisters; and provides a data routing function for the UE when the UE has service data, such as forwarding uplink (UL) data to the DN or receiving downlink (DL) data for the UE from the DN and forwarding the DL data to the (R)AN to send the DL data to the UE.

The DN provides services for users. Generally, a client is located on the UE and a server is located in the DN. The DN is a private network, such as a local area network; an external network not controlled by an operator, such as the Internet; or a proprietary network jointly deployed by operators, such as for configuring an IP multimedia subsystem (IMS) service.

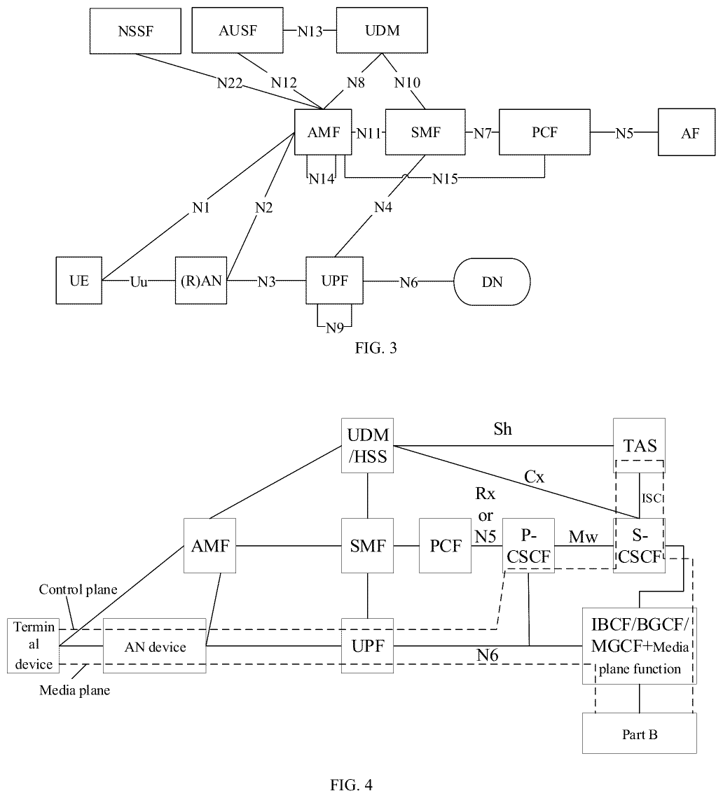

FIG. 3 is a detailed architecture determined on the basis of FIG. 2. The CN user plane includes a UPF. The CN control plane includes an authentication server function (AUSF), an AMF, an SMF, a network slice selection function (NSSF), a network exposure function (NEF), a network repository function (NRF), a unified data management (UDM), a policy control function (PCF), an application function (AF).

In the architecture shown in FIG. 3, the UE establishes an access stratum (AS) connection to the (R)AN via the Uu interface to exchange AS messages and wirelessly transmit data. The UE establishes a non-access stratum (NAS) connection to the AMF via an NI interface to exchange NAS messages. The AMF is a mobility management function in the CN. The SMF is a session management function in the CN. In addition to performing mobility management for the UE, the AMF is responsible for forwarding messages related to session management between the UE and the SMF. The PCF is a policy management function in the CN, responsible for formulating policies related to mobility management, session management, charging, and the like for the UE. The UPF is a user plane function in the CN, and transmits data with an external DN via an N6 interface and with the (R)AN via an N3 interface.

It should be noted that names of interfaces between network elements in FIG. 2 and FIG. 3 are merely examples. In specific implementation, the interfaces may have other names. This is not specifically limited in the embodiments of the present disclosure. Names of the network elements (such as the SMF, AF, and UPF) in FIG. 2 and FIG. 3 are also merely examples, and do not constitute a limitation on functions of the network elements. In the 5G system and a future network, the network elements may also have other names. This is not specifically limited in the embodiments of the present disclosure. For example, in a 6G network, at least one or all of the foregoing network elements may follow the terminology in 5G or have other names. This is described only herein and will not be repeated hereinafter. In addition, it should be understood that a name of a message (or signaling) transmitted between the foregoing network elements is merely an example, and does not constitute any limitation on a function of the message.

Before the technical solutions of the present disclosure are described, some background technical knowledge involved in the present disclosure is described. The following related technologies, as optional solutions, may be arbitrarily combined with the technical solutions in the embodiments of the present disclosure, and all fall within the protection scope of the embodiments of the present disclosure. The embodiments of the present disclosure include at least part of the following content.

FIG. 4 is a schematic diagram of a 5G system architecture according to some embodiments of the present disclosure. As shown in FIG. 4, a terminal device accesses a DN to use an IMS service. The system architecture 200 includes UE (namely the “terminal device” as described above), an AN device, AMF, SMF, UPF, UDM, PCF, proxy call session control function (P-CSCF), serving call session control function (S-CSCF), interconnection border control function (IBCF), breakout gateway control function (BGCF), media gateway control function (MGCF), and media plane function network elements, a home subscriber server (HSS), technology-associated RFS (TAS), and a Part B.

In possible embodiments, the UDM/HSS is connected to the TAS via an Sh interface. The TAS is connected to the S-CSCF via an ISC interface. The UDM/HSS is connected to the S-CSCF via a Cx interface. The PCF is connected to the P-CSCF via an Rx or N5 interface. The P-CSCF is connected to the S-CSCF via an Mw interface. A user plane optimization function (UOF) of a home network is connected to the IBCF/BGCF/MGCF and media plane function network element via an N6 interface. In addition, in FIG. 4, a control plane is a dashed line passing through the P-CSCF and the S-CSCF, and a media plane is a dashed line not passing through the P-CSCF and the S-CSCF.

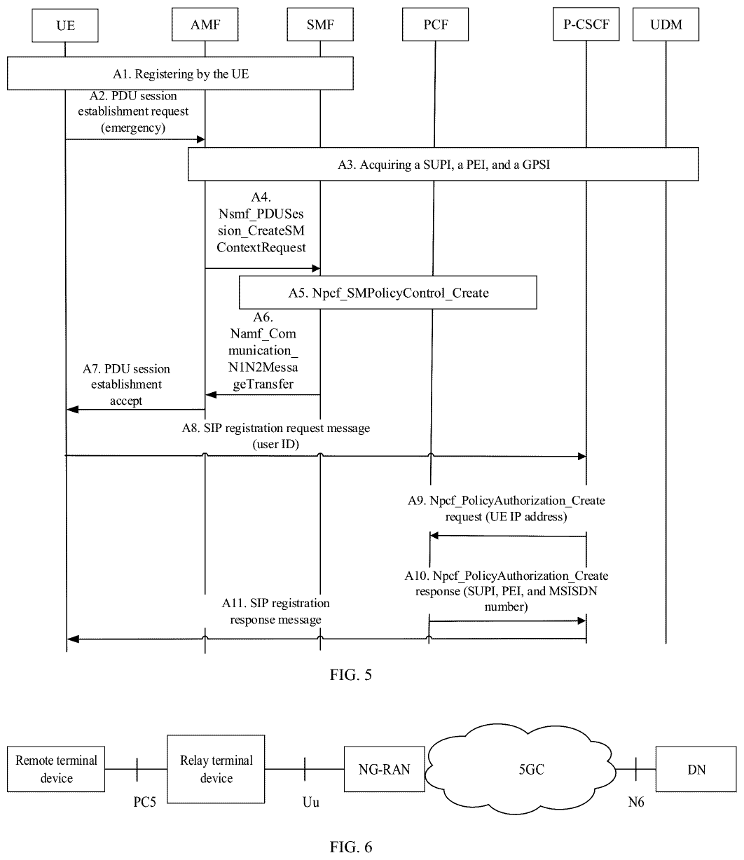

FIG. 5 is a flowchart of a method for wireless communication according to some embodiments of the present disclosure. The method is applicable to the network architecture shown in FIG. 1. The method includes at least one of the following processes (A1 to A11):

In process A1, a terminal device registers in a DN.

In process A2, the terminal device sends a protocol data unit (PDU) session establishment request (emergency) to an AMF.

UE sends a UL NAS Transport message to the AMF. The message includes a request type (set to initial emergency request), a PDU session identity (ID), and a PDU session establishment request message.

In process A3, the AMF acquires a generic public subscription identifier (GPSI, equivalent to a 4th-generation (4G) mobile station integrated services digital network (MSISDN) number) of the terminal device from a UDM (the GPSI herein is the MSISDN number).

In process A4, the AMF sends Nsmf_PDUSession_CreateSMContextRequest to an SMF.

The message carries the PDU session ID, a data network name (DNN), single-network slice selection assistance information (S-NSSAI), a request type, a subscription permanent identifier (SUPI), a permanent equipment identifier (PEI), and the GPSI.

In process A5, the SMF sends Npcf_SMPolicyControl_Create and the SUPI, PEI, and GPSI of the terminal device to a PCF.

In process A6, the SMF receives the PDU session establishment request message and sends Namf_Communication_N1N2Message Transfer to the AMF.

The message includes a PDU session establishment accept message. The PDU session establishment accept message includes a quality of service (QoS) rule, a QoS flow parameter, the DNN, the S-NSSAI, and a protocol configuration option (PCO). The PCO carries an address or a fully qualified domain name (FQDN) of a P-CSCF. If the PCO does not carry the address of the P-CSCF, the UE uses a preconfigured address of the P-CSCF or acquires the address of the P-CSCF through Dynamic Host Configuration Protocol (DHCP).

In process A7, the AMF sends a DL NAS Transport message to the UE. The message includes the PDU session establishment accept message and the PDU session ID.

In process A8, the UE sends a SIP registration request message to the P-CSCF. The message includes a user ID. The user ID is an IP multimedia private identity (IMPI).

In processes A9 and A10, the P-CSCF acquires the SUPI, an international mobile equipment identity (IMEI), and the GPSI from the PCF based on an Internet Protocol (IP) address of the UE.

In process A11, the P-CSCF returns a SIP registration response message to the terminal device.

In 3GPP R17, a proximity service (ProSe) communication solution is designed through a 5G ProSe issue. A ProSe includes an NCIS. An important scenario of the ProSe is a UE-to-network (U2N) relay scenario. U2N relay is that relay UE (a relay terminal device) relays data for remote UE (a remote terminal device) such that the remote UE (the remote terminal device) can communicate with a network. FIG. 6 is a schematic diagram of a system architecture for transmitting data to a DN for a remote terminal device via a relay terminal device according to some embodiments of the present disclosure. As shown in FIG. 6, a PC5 link is established between a remote terminal device (remote UE) and a relay terminal device (relay UE). The relay terminal device relays data from the remote terminal device to the network over a PDU session. Because each PDU session has a type, such as IP version 4 (IPv4), IP version 6 (IPv6), Ethernet, or unstructured, only data of this type can be transmitted over the corresponding PDU session. In the architecture diagram of FIG. 6, the remote terminal device does not have its own CN elements (such as an SMF, a UPF, a PCF, and an AMF). To implement relay communication, the relay terminal device and the remote terminal device need to acquire necessary configuration parameters before relay communication is performed. The configuration parameters may be from a PCF or an application server, or preconfigured on a terminal or in a subscriber identity module (SIM) card. Before transmitting data, the remote terminal device needs to discover a suitable relay terminal device and establish a PC5 connection to it.

In the embodiments of the present disclosure, a PC5 interface is a device-to-device (D2D) interface. PC5 is a direct communication interface between terminals, namely a short-range direct communication interface between vehicles, people, and road infrastructure. The interface implements low-latency, high-capacity, and high-reliability communication through direct connections, broadcasting, and network scheduling.

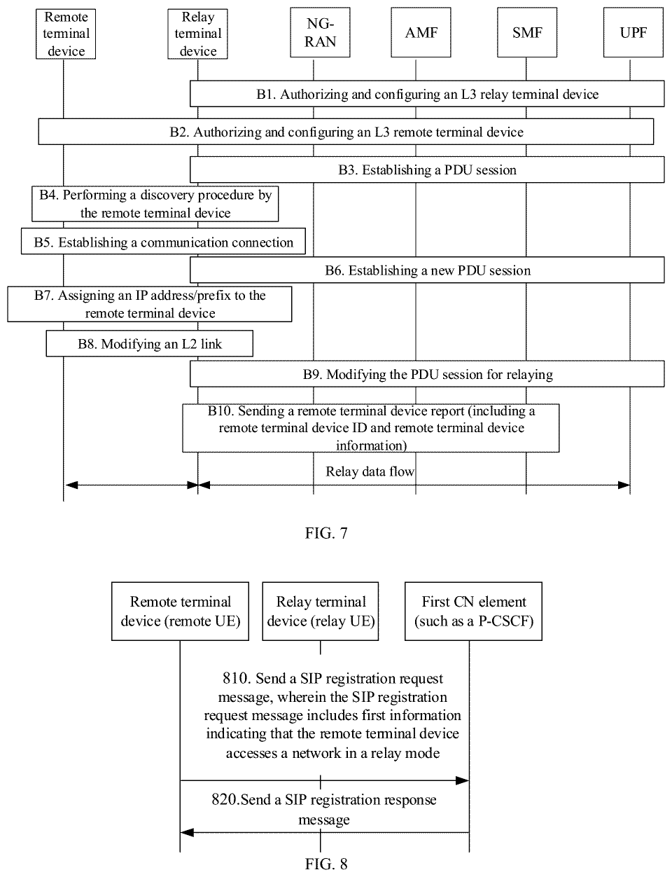

FIG. 7 is a flowchart of accessing a DN by a remote terminal device according to some embodiments of the present disclosure. The method is applicable to the system architecture shown in FIG. 6. The method includes at least one of the following processes (B1 to B10):

In process B1, a Layer-3 (L3) relay terminal device is authorized and configured via a DN.

In process B2, an L3 remote terminal device is authorized and configured via the DN.

In process B3, a PDU session is established between the relay terminal device and the DN.

Before a connection is established between the relay terminal device and the remote terminal device, the PDU session is established to subsequently relay data.

In process B4, a discovery procedure is performed by the remote terminal device.

The remote terminal device performs the discovery procedure to discover a relay terminal device that meets the requirement of the remote terminal device. During this procedure, the remote terminal device learns a connection service that the relay terminal device can provide.

In process B5, a communication connection is established between the remote terminal device and the relay terminal device.

The remote terminal device selects a relay terminal device and establishes a connection to the relay terminal device.

In process B6, a new PDU session is established by the relay terminal device in the DN.

If there is no established PDU session meeting a requirement, the relay terminal device initiates a new PDU session establishment procedure to a network before establishing a PC5 connection.

In process B7, an IP address/prefix is assigned by the relay terminal device to the remote terminal device.

For an IP-type PDU session and IP traffic on the PC5 interface, the corresponding IP address is assigned to the remote terminal device.

In process B8, a Layer-2 (L2) link is modified.

The remote terminal device provides QoS information of PC5 to the relay terminal device during an L2 link modification procedure. The relay terminal device determines a new QoS parameter based on the QoS information of PC5 and initiates a PDU session modification procedure.

In process B9, the existing PDU session is modified by the relay terminal device for relaying.

In process B10, a remote terminal device report (including a remote terminal device ID and remote terminal device information) is sent by the relay terminal device.

The remote terminal device ID identifies the remote terminal device to which the connection is established in process B5. The remote terminal device information is an auxiliary identifier for identifying a type of a PDU session established through relaying, for example, IP information of the remote terminal device for an IP-type PDU session.

In the foregoing embodiments, an SIP registration procedure is provided for a non-relay scenario, but no SIP registration procedure is provided for a relay scenario. Therefore, the embodiments of the present disclosure provide a technical solution, in which a SIP registration procedure is provided for a remote terminal device in a relay scenario, to ensure that service data of the remote terminal device can be successfully transmitted, and improve transmission reliability of a service (such as an emergency service) for the remote terminal device.

FIG. 8 is a flowchart of a method for wireless communication according to some embodiments of the present disclosure. The method is applicable to the network architecture shown in FIG. 1 or FIG. 6. The method includes at least one of the following processes (810 and 820).

In process 810, a remote terminal device sends a SIP registration request message to a first CN element in a network via a relay terminal device. The SIP registration request message includes first information indicating that the remote terminal device accesses the network in a relay mode.

The remote terminal device accesses the network via the relay terminal device. The SIP registration request message is sent by the remote terminal device to the first CN element via the relay terminal device. After receiving the SIP registration request message from the remote terminal device, the relay terminal device sends the SIP registration request message to the first CN element. Correspondingly, the first CN element receives the SIP registration request message from the remote terminal device.

The SIP registration request message is a message used for SIP registration and sent by a terminal device to a CN element. In the embodiments of the present disclosure, in a relay scenario, the remote terminal device sends the SIP registration request message to the first CN element via the relay terminal device. The SIP registration request message includes the first information. The first information indicates that the remote terminal device accesses the network in the relay mode, to distinguish the message from a SIP registration request message initiated in a non-relay mode.

In some embodiments, the SIP registration request message further includes second information indicating identity information of the remote terminal device. In some embodiments, the identity information includes at least one of an IMPI, a SUPI, a subscription concealed identifier (SUCI), a PEI, a GPSI, and an MSISDN number.

In some embodiments, the relay mode is an L3 relay mode. The first information indicates that the remote terminal device accesses the network in the L3 relay mode. FIG. 9 is a schematic diagram of a computer network OSI reference model. In a computer network OSI reference model 900, Layer-1 (L1) relay is relay at a physical layer, which is the lowest layer in the computer network OSI reference model and provides mechanical, electronic, functional, and normative characteristics for creating, maintaining, and removing physical links needed to transmit data. Transmission at the physical layer ensures that raw data can be transmitted over various physical media. L2 relay is a relay at a data link layer, which is the second layer in the computer network OSI reference model and located between the physical layer and a network layer. The data link layer provides services to the network layer on top of services provided by the physical layer. The most basic service is to reliably transmit data from the network layer to a target machine network layer of a neighboring node. L3 relay is a relay at the network layer, which is the third layer in the computer network OSI reference model and located between a transport layer and the data link layer. The network layer further manages data communication in a network based on a function provided by the data link layer for transmitting data frames between two adjacent endpoints, and manages to transmit data from a source end to a destination end via several intermediate nodes, to provide the most basic end-to-end data transmission service to the transport layer. The present disclosure provides a technical solution for implementing SIP registration of a remote terminal device in an L3 relay scenario.

In process 820, the first CN element sends an SIP registration response message corresponding to the SIP registration request message to the remote terminal device.

In some embodiments, the first CN element sends the SIP registration response message corresponding to the SIP registration request message to the remote terminal device via the relay terminal device. The relay terminal device receives the SIP registration response message corresponding to the SIP registration request message from the first CN element, and sends the SIP registration response message to the remote terminal device. Correspondingly, the remote terminal device receives, from the relay terminal device, the SIP registration response message from the first CN element. In some embodiments, the SIP registration response message indicates that the SIP registration of the remote terminal device is successful.

In some embodiments, the first CN element is acquired by the remote terminal device over a DHCP request; or the first CN element is preconfigured. In some embodiments, the first CN element is a P-CSCF.

In the technical solutions provided by the embodiments of the present disclosure, SIP registration of the remote terminal device is implemented in a relay scenario, to ensure that service data of the remote terminal device can be successfully transmitted, and improve the transmission reliability of a service (such as an emergency service) for the remote terminal device.

In some embodiments, when determining, based on the first information, that the SIP registration request message is initiated by the remote terminal device in the relay mode, the first CN element skips an authentication process for the remote terminal device and directly sends the SIP registration response message to the remote terminal device. In other words, the SIP registration response message is directly sent by the first CN element without verifying an identity of the remote terminal device when the first CN element determines, based on the first information, that the SIP registration request message is initiated by the remote terminal device in the relay mode. In some embodiments, the relay mode is the L3 relay mode.

In the technical solutions provided by the embodiments of the present disclosure, the SIP registration request message initiated by the remote terminal device is sent to the first CN element via the relay terminal device. The first CN element directly sends the SIP registration response message corresponding to the SIP registration request message to the remote terminal device. A simplified SIP registration procedure is provided for the relay scenario. That is, the first CN element directly confirms that registration of the remote terminal device is passed without a need to verify the identity of the remote terminal device. This implementation is simple and efficient.

Certainly, in the technical solutions provided by the embodiments of the present disclosure, in addition to the simplified SIP registration procedure, the embodiments of the present disclosure provide a SIP registration procedure in which registration is passed after the identity of the remote terminal device is verified, to improve SIP registration security in the relay scenario and prevent some illegal or malicious terminal devices from performing SIP registration.

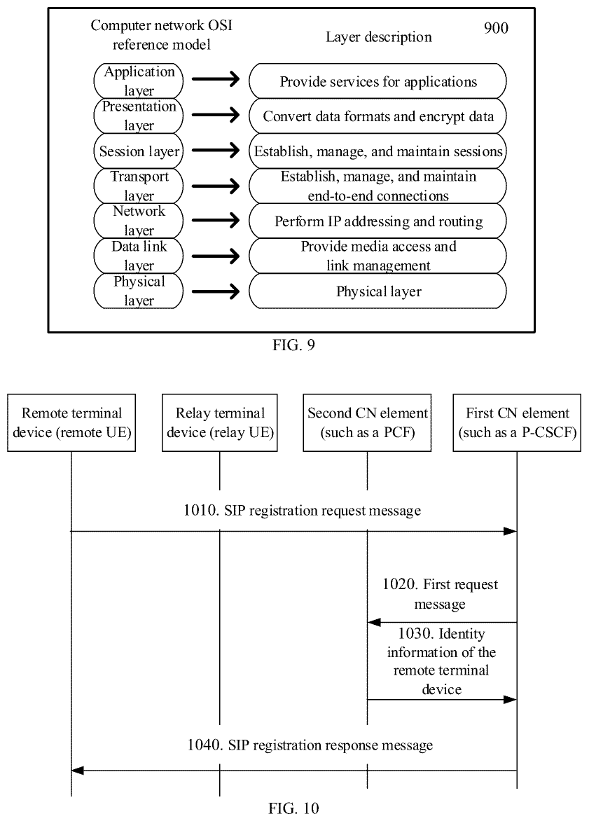

FIG. 10 is a flowchart of a method for wireless communication according to some other embodiments of the present disclosure. The method is applicable to the network architecture shown in FIG. 1 or FIG. 6. The method includes at least one of the following processes (1010 to 1040).

In process 1010, a remote terminal device sends a SIP registration request message to a first CN element.

In some embodiments, the remote terminal device sends the SIP registration request message to the first CN element in a network via a relay terminal device.

In some embodiments, the SIP registration request message includes second information indicating identity information of the remote terminal device.

In some embodiments, the SIP registration request message includes first information and second information. The first information indicates that the remote terminal device accesses the network in a relay mode, to distinguish the message from a SIP registration request message initiated in a non-relay mode. The second information indicates identity information of the remote terminal device.

The identity information of the remote terminal device is configured to represent an identity of the remote terminal device. In some embodiments, the identity information includes at least one of an IMPI, a SUPI, a SUCI, a PEI, a GPSI, and an MSISDN number. In other words, the second information indicates at least one piece of the following identity information of the remote terminal device: IMPI, SUPI, SUCI, PEI, GPSI, and MSISDN number.

In some embodiments, the first CN element is acquired by the remote terminal device over a DHCP request; or the first CN element is preconfigured. In some embodiments, the first CN element is a P-CSCF.

In some embodiments, the relay mode is an L3 relay mode.

In process 1020, the first CN element sends a first request message to a second CN element. The first request message instructs to acquire the identity information of the remote terminal device.

Correspondingly, the second CN element receives the first request message from the first CN element.

In some embodiments, the first request message includes an IP address and a port number of the remote terminal device, and third information instructing to acquire the identity information of the remote terminal device. After receiving the first request message, the second CN element acquires the identity information of the remote terminal device based on the first request message. For example, the second CN element determines, based on the third information carried in the first request message, that the request is to acquire the identity information of the remote terminal device, and then acquires the identity information of the remote terminal device from stored mapping information based on the IP address and the port number of the remote terminal device carried in the request. The mapping information includes a mapping relationship between an IP address and a port number of at least one terminal device and identity information.

In some embodiments, the second CN element is a PCF of the relay terminal device. In other words, the first CN element sends the first request message to the PCF of the relay terminal device. The first request message instructs to acquire the identity information of the remote terminal device.

In process 1030, the second CN element sends the identity information of the remote terminal device to the first CN element.

After receiving the identity information of the remote terminal device from the second CN element, the first CN element detects whether the identity information of the remote terminal device indicated in the SIP registration request message is consistent with the identity information of the remote terminal device acquired from the second CN element. If the two pieces of identity information are consistent, process 1040 is performed.

In process 1040, the first CN element sends a SIP registration response message corresponding to the SIP registration request message to the remote terminal device.

In some embodiments, the SIP registration response message indicates that SIP registration of the remote terminal device is successful.

In some embodiments, if the two pieces of identity information are inconsistent, process 1040 is not performed. That is, the first CN element does not send the SIP registration response message corresponding to the SIP registration request message to the remote terminal device, or sends a SIP registration failure message corresponding to the SIP registration request message to the remote terminal device. The SIP registration failure message indicates that the SIP registration of the remote terminal device fails.

In the technical solutions provided by the embodiments of the present disclosure, the first CN element further verifies the identity of the remote terminal device, and sends the SIP registration response message corresponding to the SIP registration request message to the remote terminal device when detecting that the identity information of the remote terminal device indicated in the SIP registration request message is consistent with the identity information of the remote terminal device acquired from the second CN element. The identity of the remote terminal device is verified to improve SIP registration security in a relay scenario and prevent some illegal or malicious terminal devices from performing SIP registration.

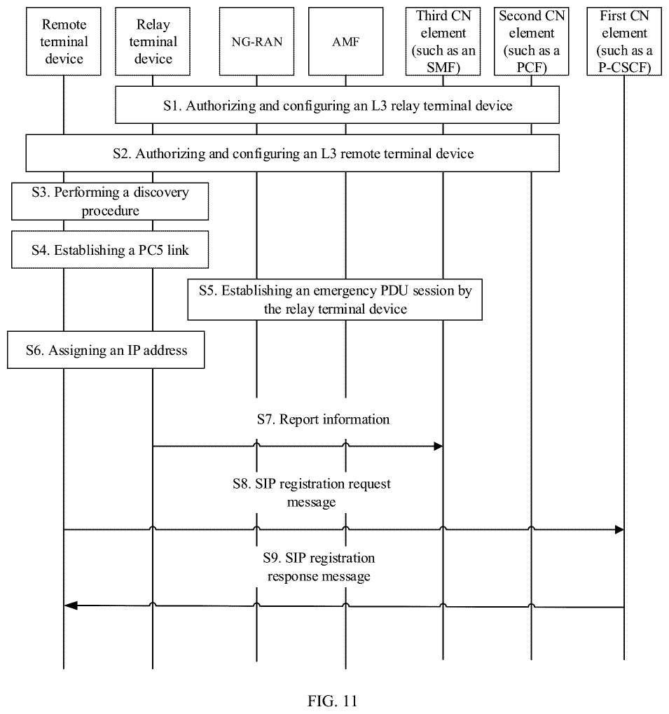

FIG. 11 is a flowchart of a method for wireless communication according to some other embodiments of the present disclosure. The method is applicable to the network architecture shown in FIG. 1 or FIG. 6. The method includes at least one of the following steps (S1 to S9):

In step S1, a PCF authorizes and configures an L3 relay terminal device.

In some embodiments, the PCF configures the relay terminal device with the following parameters:
an ID of a PLMN in which relay UE is allowed; and
a relay discovery policy and parameters, including:
   U2N relay discovery parameters: User Info ID and Relay Service Code(s);
   a default destination L2 ID for sending and receiving U2N discovery messages;
   PDU session parameters corresponding to a relay service code: PDU Session type, DNN, SSC Mode, and S-NSSAI; and
   a relay service code capable of providing an emergency service.

In step S2, the PCF authorizes and configures an L3 remote terminal device.

In some embodiments, the PCF configures the remote terminal device with the following parameters:
whether it is allowed to act as remote UE (a remote terminal device); and
a relay discovery policy and parameters, including:
   U2N relay discovery parameters: User Info ID and Relay Service Code(s);
   a default destination L2 ID for sending and receiving U2N discovery messages;
   PDU session parameters corresponding to a relay service code: PDU Session type, DNN, SSC Mode, and S-NSSAI; and
   a relay service code capable of providing an emergency service.

In step S3, the remote terminal device performs a discovery procedure.

In some embodiments, the remote terminal device performs the discovery procedure, which may be a model A discovery procedure or a model B discovery procedure. Remote UE (the remote terminal device) selects appropriate relay UE (the relay terminal device) to serve itself.

In step S4, a PC5 link is established between the remote terminal device and the relay terminal device.

In some embodiments, the remote UE (remote terminal device) initiates a PC5 link establishment procedure to the relay UE (relay terminal device) to establish a unicast communication channel. During the PC5 link establishment procedure, the remote UE (remote terminal device) provides a relay service code to the relay UE (relay terminal device). Because the remote UE (remote terminal device) wants to use an emergency service, the relay service code corresponds to the emergency service.

In step S5, the relay terminal device establishes an emergency PDU session.

In some embodiments, if the relay UE (relay terminal device) has not established the emergency PDU session, the relay UE (relay terminal device) initiates the establishment of the emergency PDU session.

In step S6, an IP address is assigned.

In some embodiments, the relay terminal device assigns the IP address to the remote terminal device.

In step S7, the relay terminal device sends report information to an SMF.

In some embodiments, the relay terminal device sends the report information to the SMF (a third CN element). The report information includes device information of the remote terminal device. The device information includes at least one of a SUPI or a SUCI.

In some embodiments, the report information includes the SUCI or the SUPI, an IP address, and a port number of the remote UE (remote terminal device).

In step S8, the remote terminal device sends a SIP registration request message to a P-CSCF.

In some embodiments, the remote terminal device sends the SIP registration request message to a first CN element (the P-CSCF).

In some embodiments, the remote UE (remote terminal device) performs P-CSCF discovery. The remote UE (remote terminal device) performs P-CSCF discovery over a DHCP request or use a preconfigured P-CSCF. The remote UE (remote terminal device) sends the SIP registration request message to the P-CSCF. The message carries a user ID. The user ID is an IMPI. The message further carries the SUPI, a PEI, and an MSISDN number. The message further carries access via L3 relay, which is configured to instruct the P-CSCF not to acquire the SUPI, PEI, and MSISDN number of the remote UE (remote terminal device) from the PCF.

In step S9, the P-CSCF sends a SIP registration response message to the remote terminal device.

In some embodiments, the P-CSCF does not acquire the SUPI, PEI, and MSISDN number from the PCF, to avoid checking consistency. The P-CSCF returns a SIP registration response to the remote terminal device.

FIG. 12 is a flowchart of a method for wireless communication according to some other embodiments of the present disclosure. The method is applicable to the network architecture shown in FIG. 1 or FIG. 6. The method includes at least one of the following processes (G1 to G14):

In process G1, a PCF authorizes and configures an L3 relay terminal device.

In process G2, the PCF authorizes and configures an L3 remote terminal device.

In process G3, the remote terminal device performs a discovery procedure.

In process G4, a PC5 link is established between the remote terminal device and the relay terminal device.

In process G5, the relay terminal device establishes an emergency PDU session.

In process G6, an IP address is assigned.

In process G7, the relay terminal device sends report information to an SMF.

Processes G1 to G7 have been described in detail in other embodiments of the present disclosure. Details of processes G1 to G7 are not described herein again.

In process G8, the SMF sends a second request message to a UDM.

A third CN element (the SMF) sends the second request message to a fourth CN element (the UDM). The second request message instructs to acquire identity information of the remote terminal device. The second request message includes device information of the remote terminal device. The second request message includes fourth information instructing to acquire the identity information of the remote terminal device.

The fourth CN element (UDM) receives the second request message from the third CN element (SMF).

In some embodiments, if an SMF of relay UE (the relay terminal device) acquires a SUPI of remote UE (the remote terminal device), the SMF sends a Nudm_SDM_Get message to a UDM of the remote UE (remote terminal device). The message carries the SUPI and a GPSI acquiring indication (the fourth information). If the SMF acquires a SUCI of the remote UE (remote terminal device), the SMF sends a Nudm_SDM_Get message to the UDM of the remote UE (remote terminal device). The message carries the SUCI and a GPSI acquiring indication (the fourth information).

In process G9, the UDM sends a second response message to the SMF.

The third CN element (SMF) receives the second response message from the fourth CN element (UDM). The second response message includes the identity information of the remote terminal device.

In some embodiments, the UDM returns the SUPI and GPSI (MSISDN number) to the SMF of the relay UE (relay terminal device).

In process G10, the SMF sends the identity information of the remote terminal device to the PCF.

The third CN element (SMF) sends the identity information of the remote terminal device to a second CN element (the PCF). The identity information of the remote terminal device is configured to be provided for a first CN element to verify an identity of the remote terminal device, to determine whether to accept an SIP registration request message initiated by the remote terminal device.

In some embodiments, the identity information includes at least one of an IMPI, a SUPI, a SUCI, a PEI, a GPSI, and an MSISDN number.

In some embodiments, the SMF of the relay UE (relay terminal device) sends the SUPI, GPSI, and PEI of the remote UE (remote terminal device) to the PCF of the relay UE (relay terminal device) through an Npcf_SMPolicyControl_Update procedure.

In process G11, the remote terminal device sends a SIP registration request message to a P-CSCF.

In some embodiments, the remote UE (remote terminal device) performs P-CSCF discovery. The remote UE (remote terminal device) may perform P-CSCF discovery over a DHCP request or use a preconfigured P-CSCF. The remote UE (remote terminal device) sends the SIP registration request message to the P-CSCF. The message carries a user ID. The user ID is an IMPI. The message further carries the SUPI, PEI, and MSISDN number. The message further carries access via L3 relay (relay indication information).

In process G12, the P-CSCF sends a first request message to the PCF.

In some embodiments, the P-CSCF acquires information about the remote UE (remote terminal device) from the PCF of the relay UE (relay terminal device). The P-CSCF sends an Npcf_Policy Authorization_Create request message to the PCF of the relay UE (relay terminal device). The message carries a UE IP address (terminal IP address, wherein the relay UE (relay terminal device) and remote UE (remote terminal device) may use the same IP address), a port number reported by the remote UE (remote terminal device), and a remote UE (remote terminal device) information acquiring indication.

In process G13, the PCF sends a first response message to the P-CSCF.

In some embodiments, the PCF of the relay UE returns an Npcf_Policy Authorization_Create response message to the P-CSCF. The message carries the SUPI, PEI, and MSISDN number of the remote UE (remote terminal device).

In process G14, the P-CSCF sends a SIP registration response message to the remote terminal device.

In some embodiments, the P-CSCF determines, based on information acquired in process G13, to accept the registration request and returns the SIP registration response message to the remote UE (remote terminal device).

The following are apparatus embodiments of the present disclosure, which are applicable to perform the method embodiments of the present disclosure. For details not disclosed in the apparatus embodiments of the present disclosure, refer to the method embodiments of the present disclosure.

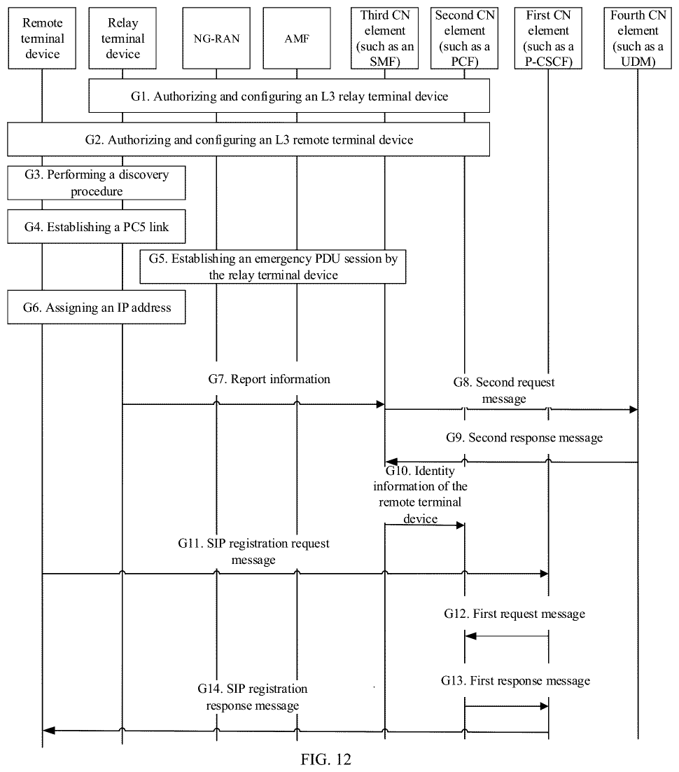

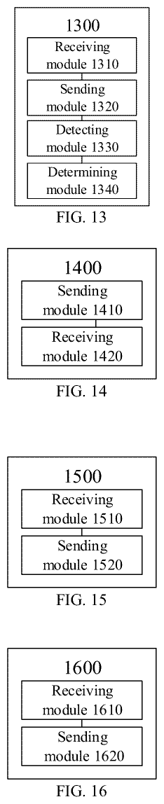

FIG. 13 is a block diagram of an apparatus for wireless communication according to some embodiments of the present disclosure. The apparatus has a function of implementing the embodiments of the foregoing method executed by the first CN element. The function is implemented by hardware or by hardware executing corresponding software. The apparatus is implemented as the first CN element or a part of the first CN element. As shown in FIG. 13, the apparatus 1300 includes a receiving module 1310 and a sending module 1320.

The receiving module 1310 is configured to receive a SIP registration request message from a remote terminal device. The remote terminal device accesses a network via a relay terminal device. The SIP registration request message is sent by the remote terminal device to a first CN element via the relay terminal device. The SIP registration request message includes first information indicating that the remote terminal device accesses the network in a relay mode.

The sending module 1320 is configured to send an SIP registration response message corresponding to the SIP registration request message to the remote terminal device.

In some embodiments, the relay mode is an L3 relay mode.

In some embodiments, in the case that determining, based on the first information, that the remote terminal device accesses the network in the relay mode, the first CN element skips an authentication process for the remote terminal device and directly sends the SIP registration response message to the remote terminal device.

In some embodiments, the SIP registration request message further includes second information indicating identity information of the remote terminal device.

In some embodiments, the apparatus further includes a detecting module 1330 and a determining module 1340.

The detecting module 1330 is configured to detect whether the identity information of the remote terminal device indicated in the SIP registration request message is consistent with identity information of the remote terminal device acquired from a second CN element.

The determining module 1340 is configured to: in a case that the identity information indicated in the SIP registration request message is consistent with the identity information acquired from the second CN element, determine to accept the SIP registration request message and send the SIP registration response message to the remote terminal device via the sending module 1320.

In some embodiments, the sending module 1320 is further configured to send a first request message to the second CN element. The first request message instructs to acquire the identity information of the remote terminal device.

The receiving module 1310 is further configured to receive the identity information of the remote terminal device from the second CN element.

In some embodiments, the first request message includes an IP address and a port number of the remote terminal device, and third information instructing to acquire the identity information of the remote terminal device.

In some embodiments, the identity information includes at least one of an IMPI, a SUPI, a SUCI, a PEI, a GPSI, or an MSISDN number.

In some embodiments, the second CN element is a PCF of the relay terminal device.

In some embodiments, the first CN element is acquired by the remote terminal device over a DHCP request; or the first CN element is preconfigured.

In some embodiments, the first CN element is a P-CSCF.

In the technical solutions provided by the embodiments of the present disclosure, SIP registration of the remote terminal device is implemented in a relay scenario, to ensure that service data of the remote terminal device can be successfully transmitted, and improve transmission reliability of a service (such as an emergency service) for the remote terminal device.

FIG. 14 is a block diagram of an apparatus for wireless communication according to some other embodiments of the present disclosure. The apparatus has a function of implementing the embodiments of the foregoing method executed by the remote terminal device. The function is implemented by hardware or by hardware executing corresponding software. The apparatus is implemented as the remote terminal device or a part of the remote terminal device. As shown in FIG. 14, the apparatus 1400 includes a sending module 1410 and a receiving module 1420.

The sending module 1410 is configured to send a SIP registration request message to a relay terminal device. The SIP registration request message is sent by the relay terminal device to a first CN element in a network. The SIP registration request message includes first information indicating that the remote terminal device accesses the network in a relay mode.

The receiving module 1420 is configured to receive an SIP registration response message corresponding to the SIP registration request message from the first CN element.

In some embodiments, the relay mode is an L3 relay mode.

In some embodiments, in the case that the first CN element determines, based on the first information, that the remote terminal device accesses the network in the relay mode, the first CN element skips an authentication process for the remote terminal device and directly sends the SIP registration response message to the remote terminal device.

In some embodiments, the SIP registration request message further includes second information indicating identity information of the remote terminal device.

In some embodiments, the SIP registration response message is sent by the first CN element in a case that the first CN element detects that the identity information of the remote terminal device indicated in the SIP registration request message is consistent with identity information of the remote terminal device acquired from a second CN element.

In some embodiments, the identity information includes at least one of an IMPI, a SUPI, a SUCI, a PEI, a GPSI, or an MSISDN number.

In some embodiments, the second CN element is a PCF of the relay terminal device.

In some embodiments, the first CN element is acquired by the remote terminal device over a DHCP request; or the first CN element is preconfigured.

In the technical solutions provided by the embodiments of the present disclosure, SIP registration of the remote terminal device is implemented in a relay scenario, to ensure that service data of the remote terminal device is successfully transmitted, and improve transmission reliability of a service (such as an emergency service) for the remote terminal device.

FIG. 15 is a block diagram of an apparatus for wireless communication according to some other embodiments of the present disclosure. The apparatus has a function of implementing the embodiments of the foregoing method executed by the relay terminal device. The function is implemented by hardware or by hardware executing corresponding software. The apparatus is implemented as the relay terminal device or a part of the relay terminal device. As shown in FIG. 15, the apparatus 1500 includes a receiving module 1510 and a sending module 1520.

The receiving module 1510 is configured to receive a SIP registration request message from a remote terminal device.

The sending module 1520 is configured to send the SIP registration request message to a first CN element. The SIP registration request message includes first information indicating that the remote terminal device accesses a network in a relay mode.

The receiving module 1510 is further configured to receive a SIP registration response message corresponding to the SIP registration request message from the first CN element.

The sending module 1520 is further configured to send the SIP registration response message to the remote terminal device.

In some embodiments, the relay mode is an L3 relay mode.

In some embodiments, in the case that the first CN element determines, based on the first information, that the remote terminal device accesses the network in the relay mode, the first CN element skips an authentication process for the remote terminal device and directly sends the SIP registration response message to the remote terminal device.

In some embodiments, the SIP registration request message further includes second information indicating identity information of the remote terminal device.

In some embodiments, the SIP registration response message is sent by the first CN element in a case that the identity information of the remote terminal device indicated in the SIP registration request message is consistent with identity information of the remote terminal device acquired from a second CN element.

In some embodiments, the identity information includes at least one of an IMPI, a SUPI, a SUCI, a PEI, a GPSI, or an MSISDN number.

In the technical solutions provided by the embodiments of the present disclosure, SIP registration of the remote terminal device is implemented in a relay scenario, to ensure that service data of the remote terminal device is successfully transmitted, and improve transmission reliability of a service (such as an emergency service) for the remote terminal device.

FIG. 16 is a block diagram of an apparatus for wireless communication according to some other embodiments of the present disclosure. The apparatus has a function of implementing the embodiments of the foregoing method executed by the second CN element. The function is implemented by hardware or by hardware executing corresponding software. The apparatus is implemented as the second CN element or a part of the second CN element. As shown in FIG. 16, the apparatus 1600 includes a receiving module 1610 and a sending module 1620.

The receiving module 1610 is configured to receive a first request message from a first CN element. The first request message instructs to acquire identity information of a remote terminal device. The remote terminal device accesses a network via a relay terminal device.

The sending module 1620 is configured to send the identity information of the remote terminal device to the first CN element such that the first CN element verifies an identity of the remote terminal device to determine whether to accept an SIP registration request message initiated by the remote terminal device.

In some embodiments, the first request message includes an IP address and a port number of the remote terminal device, and third information instructing to acquire the identity information of the remote terminal device.

In some embodiments, the identity information includes at least one of an IMPI, a SUPI, a SUCI, a PEI, a GPSI, or an MSISDN number.

In some embodiments, the second CN element is a PCF.

In the technical solutions provided by the embodiments of the present disclosure, SIP registration of the remote terminal device is implemented in a relay scenario, to ensure that service data of the remote terminal device is successfully transmitted, and improve the transmission reliability of a service (such as an emergency service) for the remote terminal device.

FIG. 17 is a block diagram of an apparatus for wireless communication according to some other embodiments of the present disclosure. The apparatus has a function of implementing the embodiments of the foregoing method executed by the third CN element. The function is implemented by hardware or by hardware executing corresponding software. The apparatus is implemented as the third CN element or a part of the third CN element. As shown in FIG. 17, the apparatus 1700 includes a receiving module 1710 and a sending module 1720.

The receiving module 1710 is configured to receive report information from a relay terminal device. The report information includes device information of a remote terminal device. The remote terminal device accesses a network via the relay terminal device.

The sending module 1720 is configured to send a second request message to a fourth CN element. The second request message instructs to acquire identity information of the remote terminal device. The second request message includes the device information of the remote terminal device.

The receiving module 1710 is further configured to receive a second response message from the fourth CN element. The second response message includes the identity information of the remote terminal device.

The sending module 1720 is further configured to send the identity information of the remote terminal device to a second CN element. The identity information of the remote terminal device is provided to a first CN element to verify an identity of the remote terminal device, to determine whether to accept an SIP registration request message initiated by the remote terminal device.

In some embodiments, the second request message includes fourth information instructing to acquire the identity information of the remote terminal device.

In some embodiments, the device information includes at least one of a SUPI or an SUCI.

In some embodiments, the identity information includes at least one of an IMPI, the SUPI, the SUCI, a PEI, a GPSI, or an MSISDN number.

In some embodiments, the third CN element is an SMF.

In the technical solutions provided by the embodiments of the present disclosure, SIP registration of the remote terminal device is implemented in a relay scenario, to ensure that service data of the remote terminal device is successfully transmitted, and improve the transmission reliability of a service (such as an emergency service) for the remote terminal device.

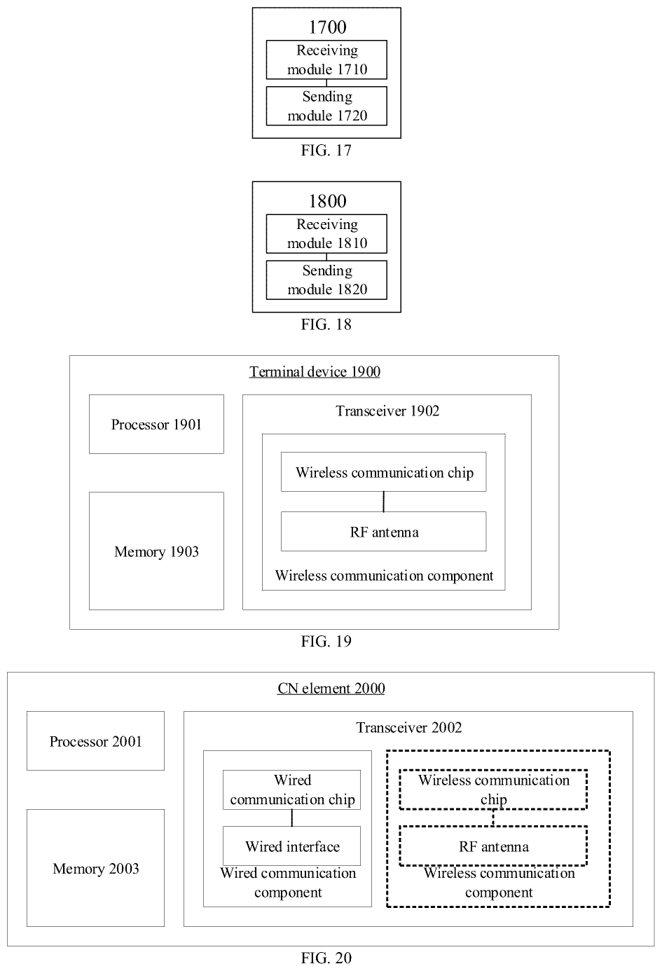

FIG. 18 is a block diagram of an apparatus for wireless communication according to some other embodiments of the present disclosure. The apparatus has a function of implementing the embodiments of the foregoing method executed by the fourth CN element. The function is implemented by hardware or by hardware executing corresponding software. The apparatus is implemented as the fourth CN element or a part of the fourth CN element. As shown in FIG. 18, the apparatus 1800 includes a receiving module 1810 and a sending module 1820.

The receiving module 1810 is configured to receive a second request message from a third CN element. The second request message instructs to acquire identity information of a remote terminal device. The second request message includes device information of the remote terminal device. The remote terminal device accesses a network via a relay terminal device.

The sending module 1820 is configured to send a second response message to the third CN element. The second response message includes the identity information of the remote terminal device. The identity information of the remote terminal device is provided to a first CN element to verify an identity of the remote terminal device, to determine whether to accept an SIP registration request message initiated by the remote terminal device.

In some embodiments, the second request message includes fourth information instructing to acquire the identity information of the remote terminal device.

In some embodiments, the device information includes at least one of a SUPI or a SUCI.

In some embodiments, the identity information includes at least one of an IMPI, the SUPI, the SUCI, a PEI, a GPSI, or an MSISDN number.

In some embodiments, the fourth CN element is a UDM network element.

In the technical solutions provided by the embodiments of the present disclosure, SIP registration of the remote terminal device is implemented in a relay scenario, to ensure that service data of the remote terminal device is successfully transmitted, and improve the transmission reliability of a service (such as an emergency service) for the remote terminal device.

FIG. 19 is a schematic structural diagram of a terminal device according to some embodiments of the present disclosure. The terminal device 1900 includes a processor 1901, a transceiver 1902, and a memory 1903.

The processor 1901 includes one or more processing cores. The processor 1901 runs a software program and module to execute various functional applications and information processing.

The transceiver 1902 includes a receiver and a transmitter. For example, the receiver and the transmitter are implemented as the same wireless communication component, and the wireless communication component includes a wireless communication chip and a radio frequency (RF) antenna.

The memory 1903 is connected to the processor 1901 and the transceiver 1902.

The memory 1903 is configured to store one or more computer programs executed by the processor. The processor 1901 is configured to execute the one or more computer programs to implement each process performed by the remote terminal device or relay terminal device in the foregoing method embodiments.

In addition, the memory 1903 is implemented by any type of transitory or non-transitory storage device or a combination thereof. The transitory or non-transitory storage device includes but is not limited to a magnetic disk or an optical disc, an electrically erasable programmable read-only memory (EEPROM), an erasable programmable read-only memory (EPROM), a static random access memory (SRAM), a read-only memory (ROM), a magnetic memory, a flash memory, or a programmable ROM (PROM).

For details not described in these embodiments, reference is made to the foregoing embodiments. Details are not described herein again.

FIG. 20 is a schematic structural diagram of a CN element according to some embodiments of the present disclosure. The CN element 2000 includes a processor 2001, a transceiver 2002, and a memory 2003.

The processor 2001 includes one or more processing cores. The processor 2001 runs a software program and module to execute various functional applications and information processing.

The transceiver 2002 includes a receiver and a transmitter. For example, the transceiver 2002 includes a wired communication component, and the wired communication component includes a wired communication chip and a wired interface (for example, a fiber interface). In some embodiments, the transceiver 2002 further includes a wireless communication component, and the wireless communication component includes a wireless communication chip and an RF antenna.

The memory 2003 is connected to the processor 2001 and the transceiver 2002.

The memory 2003 is configured to store one or more computer programs executed by the processor. The processor 2001 is configured to execute the one or more computer programs to implement each process performed by the first CN element, the second CN element, the third CN element, or the fourth CN element in the foregoing method embodiments.

In addition, the memory 2003 is implemented by any type of transitory or non-transitory storage device or a combination thereof. The transitory or non-transitory storage device includes but is not limited to a magnetic disk or an optical disc, an EEPROM, an EPROM, an SRAM, a ROM, a magnetic memory, a flash memory, or a PROM.

For details not described in these embodiments, reference is made to the foregoing embodiments. Details are not described herein again.

The embodiments of the present disclosure further provide a computer-readable storage medium storing one or more computer programs. The one or more computer programs, when loaded and run by a processor of a first CN element, cause the first CN element to perform the foregoing method for wireless communication.

The embodiments of the present disclosure further provide a computer-readable storage medium storing one or more computer programs. The one or more computer programs, when loaded and run by a processor of a remote terminal device, cause the remote terminal device to perform the foregoing method for wireless communication.

The embodiments of the present disclosure further provide a computer-readable storage medium storing one or more computer programs. The one or more computer programs, when loaded and run by a processor of a relay terminal device, cause the relay terminal device to perform the foregoing method for wireless communication.

The embodiments of the present disclosure further provide a computer-readable storage medium storing one or more computer programs. The one or more computer programs, when loaded and run by a processor of a second CN element, cause the second CN element to perform the foregoing method for wireless communication.

The embodiments of the present disclosure further provide a computer-readable storage medium storing one or more computer programs. The one or more computer programs, when loaded and run by a processor of a third CN element, cause the third CN element to perform the foregoing method for wireless communication.

The embodiments of the present disclosure further provide a computer-readable storage medium storing one or more computer programs. The one or more computer programs, when loaded and run by a processor of a fourth CN element, cause the fourth CN element to perform the foregoing method for wireless communication.

In some embodiments, the computer-readable storage medium includes a ROM, a random access memory (RAM), a solid-state drive (SSD), an optical disc, or the like. The RAM includes a resistive RAM (ReRAM) and a dynamic RAM (DRAM).

The embodiments of the present disclosure further provide a chip, including a programmable logic circuit and/or a program instruction. When running on a first CN element, the chip is configured to implement the foregoing method for wireless communication executed by the first CN element.

The embodiments of the present disclosure further provide a chip, including a programmable logic circuit and/or a program instruction. When running on a remote terminal device, the chip is configured to implement the foregoing method for wireless communication executed by the remote terminal device.

The embodiments of the present disclosure further provide a chip, including a programmable logic circuit and/or a program instruction. When running on a relay terminal device, the chip is configured to implement the foregoing method for wireless communication executed by the relay terminal device.

The embodiments of the present disclosure further provide a chip, including a programmable logic circuit and/or a program instruction. When running on a second CN element, the chip is configured to implement the foregoing method for wireless communication executed by the second CN element.

The embodiments of the present disclosure further provide a chip, including a programmable logic circuit and/or a program instruction. When running on a third CN element, the chip is configured to implement the foregoing method for wireless communication executed by the third CN element.

The embodiments of the present disclosure further provide a chip, including a programmable logic circuit and/or a program instruction. When running on a fourth CN element, the chip is configured to implement the foregoing method for wireless communication executed by the fourth CN element.

The embodiments of the present disclosure further provide a computer program product. The computer program product includes one or more computer instructions stored in a computer-readable storage medium. The one or more computer instructions, when loaded and run by a processor of a first CN element, cause the first CN element to perform the foregoing method for wireless communication.

The embodiments of the present disclosure further provide a computer program product. The computer program product includes one or more computer instructions stored in a computer-readable storage medium, wherein the one or more computer instructions, when loaded and run by a processor of a remote terminal device, cause the remote terminal device to perform the foregoing method for wireless communication.

The embodiments of the present disclosure further provide a computer program product. The computer program product includes one or more computer instructions stored in a computer-readable storage medium. The one or more computer instructions, when loaded and run by a processor of a relay terminal device, cause the relay terminal device to perform the foregoing method for wireless communication.

The embodiments of the present disclosure further provide a computer program product. The computer program product includes one or more computer instructions stored in a computer-readable storage medium, wherein the one or more computer instructions, when loaded and run by a processor of a second CN element, cause the second CN element to perform the foregoing method for wireless communication.

The embodiments of the present disclosure further provide a computer program product. The computer program product includes one or more computer instructions stored in a computer-readable storage medium, wherein the one or more computer instructions, when loaded and run by a processor of a third CN element, cause the third CN element to perform the foregoing method for wireless communication.

The embodiments of the present disclosure further provide a computer program product. The computer program product includes one or more computer instructions stored in a computer-readable storage medium, wherein the one or more computer instructions, when loaded and run by a processor of a fourth CN element, cause the fourth CN element to perform the foregoing method for wireless communication.

It should be understood that a term “indication” mentioned in the embodiments of the present disclosure is a direct indication, an indirect indication, or an association relationship. For example, A indicates B, which may mean that A directly indicates B, for example, B can be acquired through A; may mean that A indirectly indicates B, for example, A indicates C, and B can be acquired through C; or may mean an association relationship between A and B.

In the description of the embodiments of the present disclosure, a term “corresponding” may indicate a direct or indirect correspondence between two objects, an association relationship between the two objects, or a relationship between indication and being indicated, between configuration and being configured, or the like.

In some embodiments of the present disclosure, “predefinition” may be implemented by pre-storing corresponding code or a corresponding table in a device (such as a terminal device or a CN element) or through another method that can be used to indicate relevant information, and a specific implementation method thereof is not limited in the present disclosure. For example, a predefined thing may be a thing defined in a protocol.

In some embodiments of the present disclosure, the “protocol” may be a standard protocol in the communication field, for example, an LTE protocol, an NR protocol, and a related protocol applied in a future communication system. This is not limited in the present disclosure.

The term “a plurality of” in this specification means two or more. The term “and/or” describes associations between associated objects, and it indicates three types of relationships. For example, the phrase “A and/or B” means (A), (B), or (A and B). The character “/” usually indicates an “or” relationship between associated objects.

In addition, the process/step number in this specification only exemplifies one possible process/step execution order. In some other embodiments, the above processes/steps may also be executed without following a numbering order. For example, two processes/steps with different numbers are executed simultaneously or in an order revere to the order shown in the figures. This is not limited in the embodiments of the present disclosure.

A person skilled in the art should be aware that in the foregoing one or more examples, the functions described in the embodiments of the present disclosure may be implemented by hardware, software, firmware, or any combination thereof. When implemented by software, the functions may be stored in a computer-readable medium or transmitted as at least one instruction or code on the computer-readable medium. The computer-readable medium includes a computer storage medium and a communication medium. The communication medium includes any medium that facilitates the transfer of a computer program from one place to another. The storage medium may be any usable medium accessible by a general-purpose computer or a special-purpose computer.

The foregoing descriptions are merely exemplary embodiments of the present disclosure and are not intended to limit the present disclosure. Any modification, equivalent replacement, and improvement within the principle of the present disclosure shall be included within the protection scope of the present disclosure.

1. A method for wireless communication, applicable to a first core network (CN) element in a network, the method comprising:
receiving a Session Initiation Protocol (SIP) registration request message from a remote terminal device, wherein the remote terminal device accesses the network via a relay terminal device, the SIP registration request message is sent by the remote terminal device to the first CN element via the relay terminal device, and the SIP registration request message comprises first information indicating that the remote terminal device accesses the network in a relay mode; and
sending a SIP registration response message corresponding to the SIP registration request message to the remote terminal device.

2. The method according to claim 1, wherein the relay mode is a Layer-3 (L3) relay mode.

3. The method according to claim 1, wherein in a case that the first CN element determines, based on the first information, that the remote terminal device accesses the network in the relay mode, the first CN element skips an authentication process for the remote terminal device and directly sends the SIP registration response message to the remote terminal device.

4. The method according to claim 1, wherein the SIP registration request message further comprises second information indicating identity information of the remote terminal device, and the identity information comprises an IP multimedia private identity (IMPI).

5. The method according to claim 4, wherein the first CN element sends a first request message to a policy control function (PCF) network element, and the first request message instructs to acquire the identity information of the remote terminal device.

6. The method according to claim 5, wherein the first CN element receives the identity information of the remote terminal device from the PCF network element, and the identity information comprises one of a subscription permanent identifier (SUPI), a permanent equipment identifier (PEI), or a generic public subscription identifier (GPSI).

7. The method according to claim 1, wherein the first CN element is acquired by the remote terminal device over a Dynamic Host Configuration Protocol (DHCP) request.

8. The method according to claim 1, wherein the first CN element is a proxy call session control function (P-CSCF) network element.

9. A communication device, comprising:
a processor and a memory storing one or more computer programs, which when executed by the processor, causes the communication device to:
receive a Session Initiation Protocol (SIP) registration request message from a remote terminal device, wherein the remote terminal device accesses a network via a relay terminal device, the SIP registration request message is sent by the remote terminal device to a first core network (CN) element via the relay terminal device, and the SIP registration request message comprises first information indicating that the remote terminal device accesses the network in a relay mode; and
send a SIP registration response message corresponding to the SIP registration request message to the remote terminal device.

10. The communication device according to claim 9, wherein the relay mode is a Layer-3 (L3) relay mode.

11. The communication device according to claim 9, wherein in a case that the first CN element determines, based on the first information, that the remote terminal device accesses the network in the relay mode, the first CN element skips an authentication process for the remote terminal device and directly sends the SIP registration response message to the remote terminal device.

12. The communication device according to claim 9, wherein the SIP registration request message further comprises second information indicating identity information of the remote terminal device, and the identity information comprises an IP multimedia private identity (IMPI).

13. The communication device according to claim 12, wherein the first CN element sends a first request message to a policy control function (PCF) network element, and the first request message instructs to acquire the identity information of the remote terminal device.

14. The communication device according to claim 13, wherein the first CN element receives the identity information of the remote terminal device from the PCF network element, and the identity information comprises one of a subscription permanent identifier (SUPI), a permanent equipment identifier (PEI), or a generic public subscription identifier (GPSI).

15. The communication device according to claim 9, wherein the first CN element is acquired by the remote terminal device over a Dynamic Host Configuration Protocol (DHCP) request.

16. The communication device according to claim 9, wherein the first CN element is a proxy call session control function (P-CSCF) network element.

17. A communication device, comprising:
a processor and a memory storing one or more computer programs, which when executed by the processor, causes the communication device to:
send a Session Initiation Protocol (SIP) registration request message to a relay terminal device, wherein the SIP registration request message is sent by a remote terminal device via the relay terminal device to a first core network (CN) element in the network, and the SIP registration request message comprises first information indicating that the remote terminal device accesses the network in a relay mode; and
receive a SIP registration response message corresponding to the SIP registration request message from the first CN element.

18. The communication device according to claim 17, wherein the relay mode is a Layer-3 (L3) relay mode.

19. The communication device according to claim 17, wherein in a case that the first CN element determines, based on the first information, that the remote terminal device accesses the network in the relay mode, the first CN element skips an authentication process for the remote terminal device and directly sends the SIP registration response message to the remote terminal device.

20. The communication device according to claim 17, wherein the SIP registration request message further comprises second information indicating identity information of the remote terminal device, and the identity information comprises an IP multimedia private identity (IMPI).
